(19) United States
(12) Patent Application Publication
(10) Pub. No.: US 2026/0087433 A1
(43) Pub. Date: Mar. 26, 2026

(54) SYSTEMS AND METHODS FOR PROCESS PERFORMANCE VIA AUTONOMOUS AGENT

(71) Applicant: ServiceNow, Inc., Santa Clara, CA (US)

(72) Inventors: Gaurav Goyal, San Jose, CA (US); Avishek Dalal, Hyderabad (IN); Chaitanya Saragadam, Hyderabad (IN); Suhas Kalya Sridhar, Bengaluru (IN)

(21) Appl. No.: 18/895,306

(22) Filed: Sep. 24, 2024

(51) Int. Cl. G06Q 10/0633; G06Q 10/0639

(52) U.S. Cl. CPC G06Q 10/0633; G06Q 10/0639

(57) ABSTRACT

A method includes receiving an indication of a process to be performed from a client device, identifying a first workflow associated with a first task of the process, identifying a second workflow associated with a second task of the process, initiating performance of the first and second workflows, and transmitting an indication of completion of the performance of the first and second workflows to the client device.

### TECHNICAL FIELD

The present disclosure relates generally to autonomous agents, and more specifically to using autonomous agents to perform complex processes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

Processes performed within an enterprise that utilizes cloud-based architectures may include tasks and subtasks that are manually performed by one or more humans and may span multiple domains (e.g., human resources, information technology, finance, facilities, operations, etc.) within the enterprise. Processes that utilize existing workflows and/or automations may rely on human inputs to select, initiate, and monitor the workflows and/or automations, as well as to pass results from one workflow and/or automation to a subsequent workflow and/or automation. Reliance on human inputs in performing processes may result in inefficient selection of workflows and/or automations, inefficient use of computing resources in performing the processes, pauses in performance of tasks and/or subtasks waiting on human inputs, errors that result in incorrect performance of processes and/or incorrect results of processes. Accordingly, improved techniques for utilizing workflows and automations to perform processes within an enterprise are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving an indication of a process to be performed from a client device, identifying a first workflow associated with a first task of the process, identifying a second workflow associated with a second task of the process, initiating performance of the first and second workflows, and transmitting an indication of completion of the performance of the first and second workflows to the client device.

In another embodiment, a system includes processing circuitry and a memory. The memory is accessible by the processing circuitry and stores instructions that, when executed by the processing circuitry, cause the processing circuitry to implement a client instance. The client instance is configured to receive an indication of a process to be performed from a client device, identify a first workflow associated with a first task of the process, identify a second workflow associated with a second task of the process, initiate performance of the first and second workflows, and transmit an indication of completion of the performance of the first and second workflows to the client device.

In a further embodiment, a non-transitory, computer readable medium comprising instructions that, when executed by processing circuitry, cause the processing circuitry to receive an indication of a process to be performed from a client device, identify a first workflow associated with a first task of the process, identify a second workflow associated with a second task of the process, initiate performance of the first and second workflows, and transmit an indication of completion of the performance of the first and second workflows to the client device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance, in accordance with aspects of the present disclosure;

FIG. 5 illustrates an architecture used for performing processes via an autonomous agent, in accordance with aspects of the present disclosure;

FIG. 6 illustrates an architecture in which multiple autonomous agents are utilized to perform a task, in accordance with aspects of the present disclosure;

FIG. 7 illustrates a data model used for process performance via one or more of the autonomous agents of FIGS. 5 and 6, in accordance with aspects of the present disclosure;

FIG. 8 is a flow chart of a process for large language model (LLM)-based search that may be used by one or more of the autonomous agents of FIGS. 5 and 6 in task decomposition, task performance, reflection, and so forth, in accordance with aspects of the present disclosure;

FIG. 9 is a flow chart of a process for an embeddings-based search that may be used by one or more of the autonomous agents of FIGS. 5 and 6 in task decomposition, task performance, reflection, and so forth, in accordance with aspects of the present disclosure;

FIG. 10 is a flow chart of a process for recursive task decomposition, in accordance with aspects of the present disclosure;

FIG. 11 is a flow chart of a process for performing recursive decomposition with reflection, which may include the LLM-based search process of FIG. 8 and the embedding-based search process of FIG. 9, in accordance with aspects of the present disclosure;

FIG. 12 is a flow chart of a process for decomposition reflection, in accordance with aspects of the present disclosure;

FIG. 13 is a screenshot of a chat conversation in which a process is requested and performed via one or more of the autonomous agents of FIGS. 5 and 6, in accordance with aspects of the present disclosure;

FIG. 14 is a screenshot of a chat conversation in which another process is requested and performed via one or more of the autonomous agents of FIGS. 5 and 6, in accordance with aspects of the present disclosure;

FIG. 15 is a flow chart of a process for performing a process via one or more of the autonomous agents of FIGS. 5 and 6, in which decomposition is performed before any tasks are initiated, in accordance with aspects of the present disclosure; and

FIG. 16 is a flow chart for performing a process via one or more of the autonomous agents of FIGS. 5 and 6, in which decomposition is performed iteratively as tasks are performed, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Processes performed within an enterprise may include tasks and subtasks that are manually performed by one or more humans and may span multiple domains (e.g., human resources, information technology, finance, facilities, operations, etc.) within the enterprise. Processes that utilize existing workflows and/or automations may rely on human inputs to select, initiate, and monitor the workflows and/or automations, as well as to pass results from one workflow and/or automation to a subsequent workflow and/or automation. Reliance on human inputs in performing processes may result in inefficient selection of workflows and/or automations, inefficient use of computing resources in performing the processes, pauses in performance of tasks and/or subtasks waiting on human inputs, errors that result in incorrect performance of processes and/or incorrect results of processes. Accordingly, improved techniques for utilizing workflow and automations to perform processes within an enterprise are needed.

Various embodiments disclosed herein are directed to performing processes via an autonomous agent. A natural language request to perform a process may be received from a client device. The autonomous agent decomposes the process into a group of tasks. In some cases, individual tasks may be further decomposed into subtasks, which may be even further decomposed and so on until the process has been decomposed into a sequence of existing workflows and/or automations. If a task or subtask cannot be decomposed into components made up of existing workflows and/or automations, new workflows and/or automations may be created based on one or more pieces of contextual information (e.g., related knowledge base articles). In some embodiments, the process may be fully decomposed before any of the tasks or subtasks are performed. In such embodiments, the autonomous agent may provide the decomposed process to an LLM and/or to the client device for approval. In other embodiments, the autonomous agent may identify a first task, provide the proposed first task to an LLM and/or the client device for approval, upon receipt of approval, perform the first task, identify a subsequent task, provide the proposed subsequent task to an LLM and/or the client device for approval, upon receipt of approval, perform the subsequent task, and so on until the process is completed. Alternatively, a combination of such approaches may be implemented in which a portion of the process may be initially fully decomposed (e.g., autonomously) and the remainder may be decomposed piece-meal and/or with review and approval steps. In some embodiments, the autonomous agent may be a primary autonomous agent that delegates performance of tasks and/or subtasks to one or more secondary agents. In such embodiments, the primary autonomous agent may utilize more sophisticated, and thus more expensive to operate, large language models (LLMs), whereas the secondary autonomous agent may utilize more general purpose LLMs to perform tasks and/or subtasks. In some embodiments, however, secondary autonomous agents may utilize more specialized LLMs to perform more specific tasks. If the autonomous agent is unable to perform a task or subtask autonomously, the autonomous agent may request help and/or input from a human agent, or may transmit a request for more information or additional input to the client device. By utilizing the disclosed techniques, performance of processes within an enterprise may include improved selection of workflows and/or automations, more efficient utilization of computing resources in performing processes, reduced downtime in performance of tasks and/or subtasks waiting on human inputs, and fewer errors that may cause incorrect performance of processes and/or incorrect results of processes.

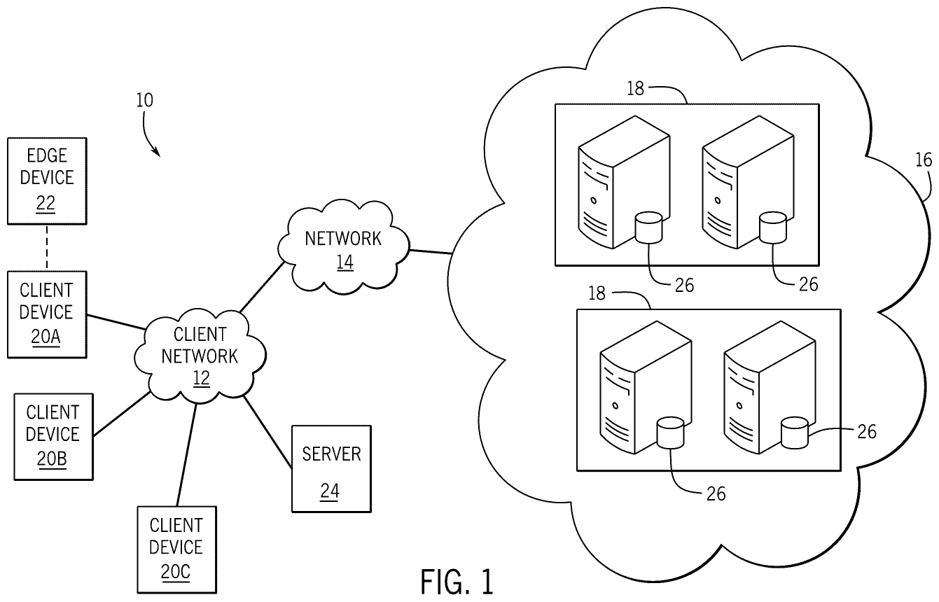

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

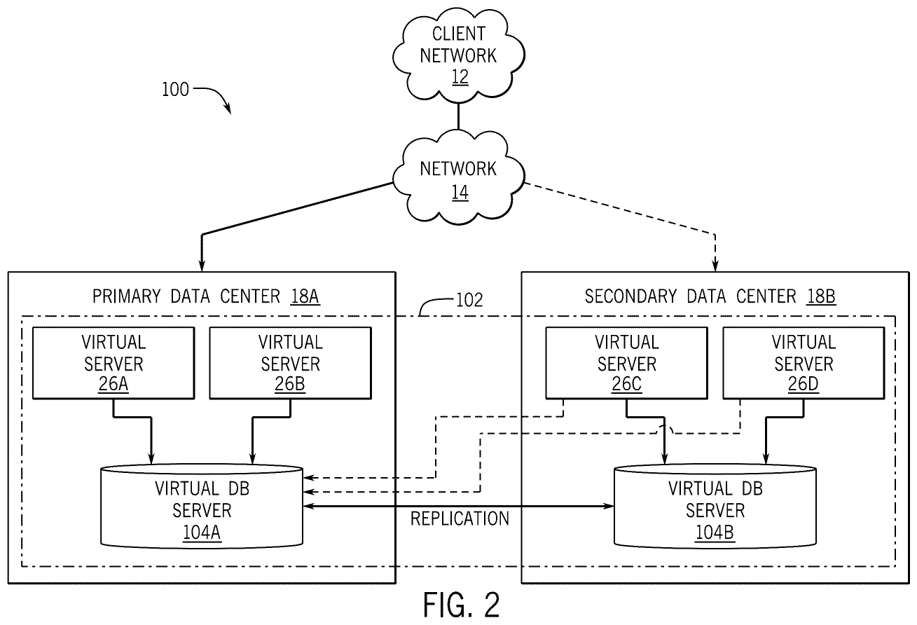

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

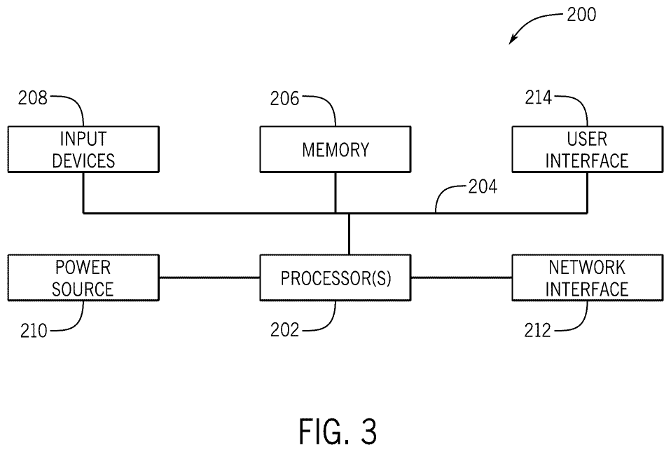

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

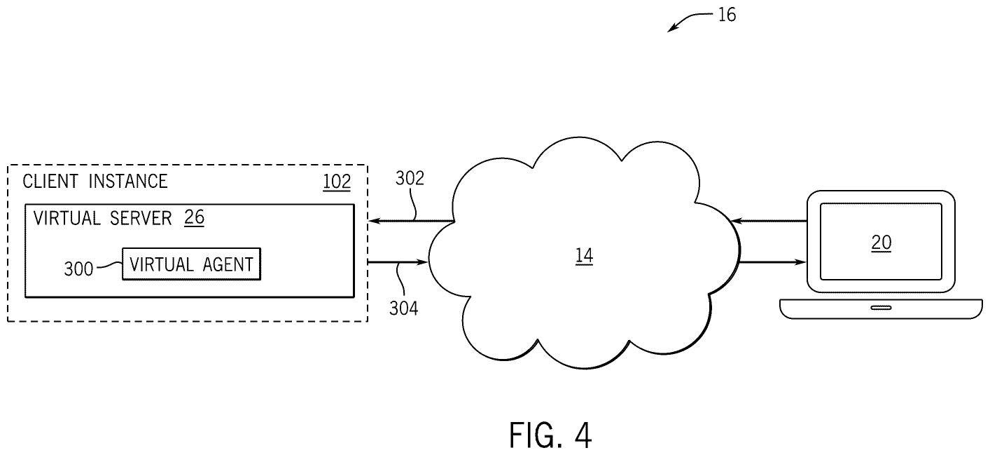

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). For example, the client device 20 may access a virtual agent 300 running within the client instance 102. The client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser.

The client device 20 may interface with the virtual agent 300 via a chat interface, a voice interface, email, or some other interface. For example, the client device 20 may provide inputs 302 requesting that the virtual agent perform certain tasks (e.g., retrieve data, initiate and/or execute workflows, automations, tasks, etc.). In some embodiments, the inputs 302 may include or be accompanied by data used by the virtual agent 300 to perform the requested tasks. During or following execution of the requested tasks, the virtual agent 300 may generate outputs 304 requesting additional inputs, providing results of performing requested tasks, providing notification of status updates and/or task completion requesting feedback, and so forth. In some embodiments, the input 302 may request that the virtual agent perform a task for which there is a defined workflow or automation. In such embodiments, the virtual agent 300 initiates the workflow or automation, requests additional inputs as needed, and provides the client device 20 with outputs 304 including the results of the performed task, and/or indicating that the task has been completed. In other embodiments, the inputs 302 may ask the virtual agent 300 to perform a task for which there is not a defined workflow or automation. Typically, in such cases, the virtual agent hands the task off to a human for completion. Such tasks are often manually performed, labor intensive, complex, inefficient, and prone to error. However, using the disclosed techniques, the virtual agent decomposes the requested task into a series of previously-defined tasks and/or workflows (e.g., automations). If there are no previously-defined tasks and/or workflows, the virtual agent creates new tasks, workflows, and/or automations using available information, such that the virtual agent can perform the requested task without human agent intervention or with greatly reduced human intervention.

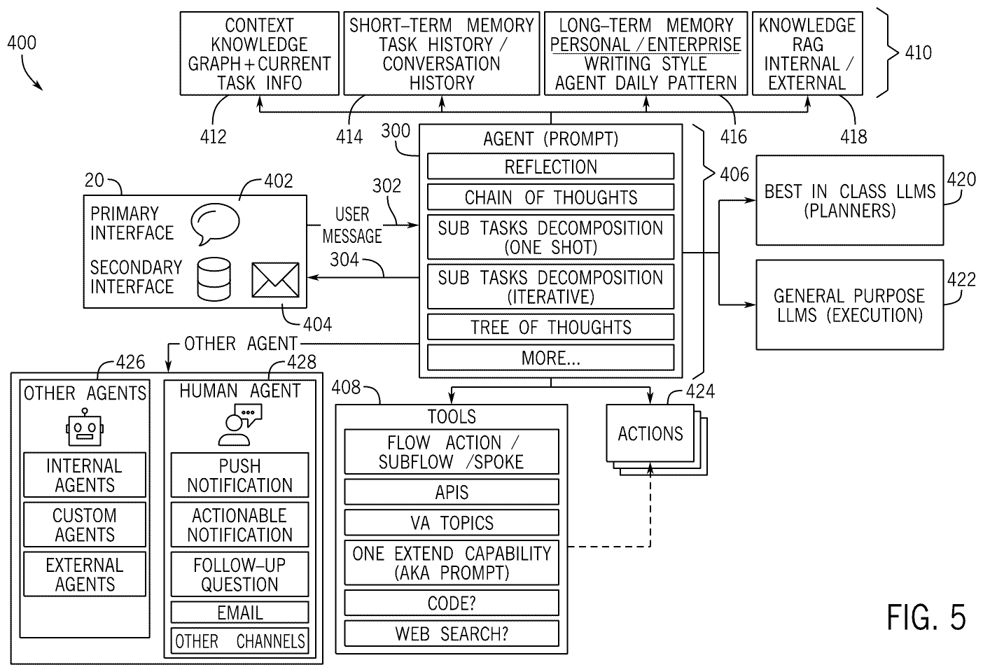

FIG. 5 illustrates an architecture 400 used for performing processes via an autonomous virtual agent 300. As shown, and previously described, the virtual agent 300 receives an input 302 from the client device, which may be received via a primary interface 402, such as a text or voice-based chat session, or a secondary interface 404, such as an email, a database query, a messaging application, a native application, a web browser, etc. The virtual agent 300 may have a series of embedded capabilities 406 for processing the input. For example, the virtual agent 300 may use a reflection capability to receive external feedback or generate internal feedback on a plan to perform one or more tasks and modify the plan based on the feedback. Along these lines, the virtual agent 300 may generate a chain of thoughts (e.g., a linear progression of intents that eventually lead to an answer to a question or a resolution to a problem) or a tree of thoughts (e.g., a number of paths for solving a problem or answering a question, with the LLM evaluating the validity of the current path at each intermediate step) based on received external feedback, generated internal feedback, or other internal/external data. As will be discussed in more detail below, the virtual agent may be capable of decomposing tasks requested via inputs 302 into subtasks. As used herein, decomposing tasks means breaking tasks into subtasks (as well as sub-subtasks, and sub-sub-subtasks, and so forth, as needed) until the resulting tasks and subtasks can be performed using defined actions and/or workflows. If defined actions and/or workflows do not exist, in some embodiments, the virtual agent 300 may define new actions and/or workflows based on available knowledge to perform actions and/or workflows for which no existing actions and/or workflows exist. Tasks may be fully decomposed in a single stint before any actions are performed (e.g., “one shot decomposition”), or tasks may be iteratively decomposed such that a first action or workflow is identified, the virtual agent performs the identified actions/workflow and then decomposes the task to determine the next action/workflow.

The virtual agent 300 may also have access to one or more external tools 408 that may be utilized in processing (e.g., decomposing) and/or performing tasks. For example, the virtual agent 300 may have access (e.g., via a database, application, application programming interface (API), etc.) to a collection of workflows, workflow actions, sub-flows, spokes, and so forth that may be utilized to decompose tasks and to perform tasks. Further, the virtual agent 300 may have access to APIs to interface with one or more applications and/or services, virtual agent topics to guide the virtual agent through conversations about various subjects, capabilities for configuring providers of various services utilized by the virtual agent 300, access to underlying code for various applications, workflows, actions, capabilities, etc. In some embodiments, the virtual agent 300 may also have access to a web search provider to search the web for definitions of terms, how to perform certain tasks, open source code, and so forth.

The virtual agent 300 may also have access to various data sets 410 that can be used to decompose and perform tasks. For example, the virtual agent 300 may have access to one or more sets of context data 412 that may include, for example, any data that accompanies the input 302, any knowledge graphs (e.g., graphs created using a graph-structured data model to represent and organize data) associated with the one or more tasks, subtasks, and/or data referenced by the input, workflows, actions, etc. Short term memory 414 may include, for example, task history (e.g., what tasks have been performed recently or are queued for performance in the near future), conversation/chat history, and so forth. Long term memory 416 may include, for example, personal data for the requestor, anyone for whom actions are performed, and/or a person who is the subject of one or more actions (e.g., a newly hired person during an onboarding process), writing style guides/policies, agent activity trends/patterns, and so forth. Knowledge data 418 may include data generated from retrieval augmented generation, which is a natural language processing (NLP) technique that combines artificial intelligence (AI) models to improve the output of a large language model (LLM), knowledge base articles for the enterprise, service providers, partners, etc., as well as internal and external data.

As shown, the virtual agent 300 may also utilize one or more specialized LLMs 420 and/or one or more general purpose LLMs 422, which, as is described in more detail below, may be used to check task decomposition, perform tasks, generate outputs 304, and so forth. As shown and previously described, the virtual agent 300 decomposes a task into a series of defined workflows and subflows, which are made up of actions 424, as well as individual actions 424, which may create a sequence of actions 424 to be performed by the virtual agent 300.

For example, for the virtual agent 300 to perform employee on-boarding and/or off-boarding, the virtual agent 300 receives an initiation command, requesting that the virtual agent 300 perform the onboarding workflow for a new hire, retrieves the new hire's data from a human resources (HR) system, sets up accounts, and assigns necessary access rights using APIs, and schedules orientation and training by interfacing with calendar and training platforms. For offboarding, the virtual agent 300 may reverse the process, removing access and archiving user data according to company policy.

For the virtual agent 300 to perform incident management, the virtual agent 300 may ingest incidents from a ticketing system, use artificial intelligence (AI) to categorize and prioritize the incidents by analyzing the content and comparing incidents with historical data, assign the ticket to the appropriate team or individual based on expertise and current workload, monitor progress, and send automated follow-ups if necessary.

For the virtual agent 300 to perform vendor management, the virtual agent 300 may compile vendor data from various sources into a unified dashboard, track performance metrics in real-time against service level agreements (SLAs), perform compliance checks, generate alerts for any deviations that arise during compliance checks, and manage contract renewals and terminations through predefined workflow automation.

For the virtual agent 300 to perform compliance and audit management, the virtual agent 300 may load regulatory requirements into a system as rules and checkpoints, regularly check systems and processes against compliance measures, generate reports detailing compliance status and any issues that arise, and automat audit preparation by collating documents and logs.

For the virtual agent 300 to perform capacity planning, the virtual agent 300 may analyze historical data to understand usage patterns and trends, use predictive models to forecast future demand for services, provision and/or deprovision resources to meet forecasted demands, and optimize for cost, performance, and availability.

For the virtual agent 300 to perform information technology (IT) finance management, the virtual agent 300 may integrate financial data from IT services into a system, automate budget tracking, billing, and chargeback to departments, identify cost-saving opportunities through analytics, and generate and distribute financial reports.

For the virtual agent 300 to perform “what-if” analytics, the virtual agent 300 may take input scenarios from users regarding changes in IT infrastructure or policies, run simulations based on current data and models the impact of those changes, analyze outcomes to suggest the most favorable scenarios, and create reports on potential impacts for decision support.

For the virtual agent 300 to perform “ad-hoc” analytics, the virtual agent 300 may receive user queries with spontaneous data requests, access disparate data sources to gather relevant information, apply AI algorithms to analyze the data and uncover insights, and create custom reports and visualizations to be presented to the user.

For the virtual agent 300 to perform knowledge management, the virtual agent 300 may crawl and index knowledge articles, documentation, and frequently asked questions (FAQs), process search queries using natural language processing (NLP) to understand context and deliver accurate results, present relevant articles to users, use feedback to refine future searches, and identify gaps in knowledge and flags for content creation.

For the virtual agent 300 to perform self-service diagnostics, the virtual agent 300 may guide the user through a series of diagnostic steps when an issue is reported, analyze user input and system data to pinpoint issues, suggest solutions to users, with the option to escalate if self-resolution is not possible, and log the interaction to improve future diagnostics.

For the virtual agent 300 to perform AI for problem analysis, the virtual agent 300 may collect data related to an incident, including logs, user reports, and system metrics, use AI to analyze collected data to identify patterns and potential causes, recommend solutions and/or automate corrective actions, and document resolution processes and feedback resolution processes for learning.

In some cases, a virtual agent may encounter a task that it cannot perform or that cannot be automated. In such cases, the virtual agent may utilize one or more other non-human agents 426, such as service provider agents, enterprise agents, custom agents, external agents, etc., or one or more human agents 428 (e.g., via push notification, actionable notifications, follow-up questions, emails, chat messages, or other channels,) to perform the task.

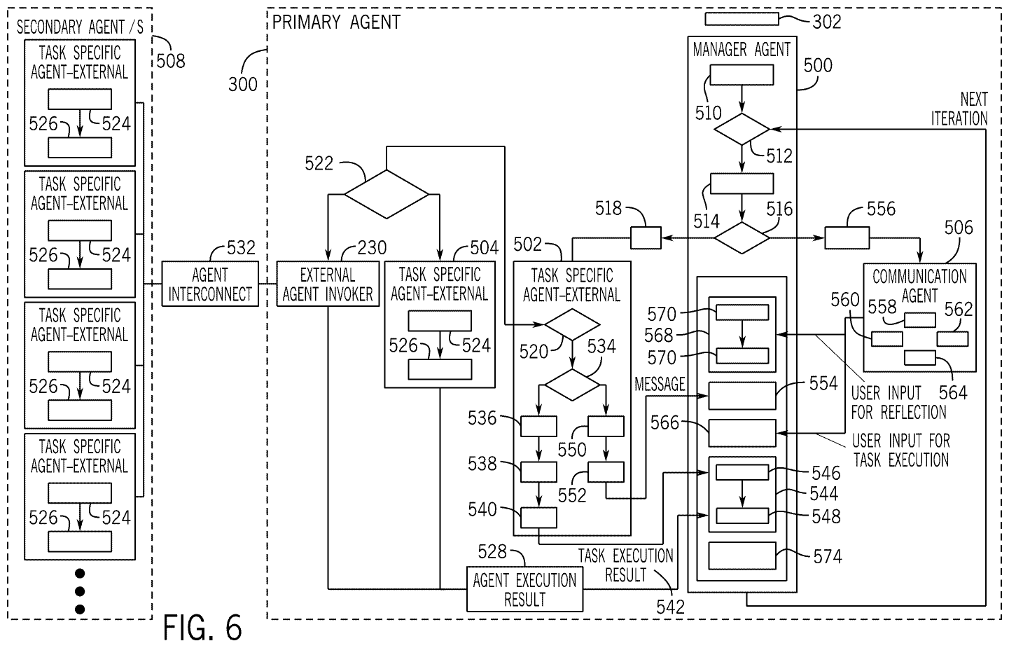

In some embodiments, the virtual agent (e.g., the “primary” agent) may be a collection of agents. FIG. 6 illustrates an architecture in which multiple autonomous agents are utilized together (i.e., in the aggregate) to perform a task. For example, the virtual agent 300 (e.g., a primary agent) may include multiple component agents, such as a manager agent 500, an executor agent 502, one or more task specific agents 504, and a communication agent 506. The virtual agent may also interface with one or more secondary agents 508, which may include the other agents 426 and the human agents 428 shown in FIG. 5.

The manager agent 500 is generally responsible for handling the flow of the overall execution of a requested process. This may include, for example, planning and decomposition, delegation of subtasks in the plan to actions or agents, coordinating communication between the executor agent 502 and the communication agent 506, reflection and mid-execution decision making, and co-piloting with a human in the loop.

The executor agent 502 is generally responsible for fulfilling a given single task assigned by the manager agents with an available resolution, either through an executable action or through an agent. This may include, for example, procuring inputs for a given action from context and recognizing missing values, requesting the manager agent 500 for user input to fill missing values, and, invoking secondary agents 508 if resolution points to an agent.

The communication agent 506 is generally responsible for providing a way to interface with the user (e.g., requestor), either for obtaining an input or displaying an agent response on a current channel. The communication agent 506 may communicate via push notifications, chat, an activity stream (work notes, comments, case journal entries, etc.), email, and so forth.

As shown, when a trigger 302 is activated (e.g., a request to perform a process is received), an input is passed to the manager agent 500. At 510, the manager agent performs decomposition and delegation, which involves breaking a process into component tasks and subtasks until all of the tasks and subtasks can be performed via defined workflows and actions, and using semantic search to identify agents or other resources to perform the component tasks and subtasks. As previously described, decomposition may be performed all at once (e.g., before any of the tasks and subtasks are performed) or iteratively (e.g., as tasks and subtasks are performed). At decision block 512, the manager agent 500 checks termination of the process. If the termination of the process has not been reached (e.g., there are still component tasks and/or subtasks to be performed for completion of the process), the manager agent 500 proceeds to 514 and checks the current progress of the process. This may include, for example, obtaining an index of the current task and checking to see if user input was requested during the last iteration of that task. At 516, the manager agent 500 determines whether a resolution has been identified for the task (e.g., can the task be performed via a defined workflow and/or action, and/or has a resource been identified to perform the action), and whether user input will be requested. If, at 518, a resolution exists and user input will not be requested, the manager agent 500 passes the task to the executor agent 502.

If, at 520, the executor agent 502, determines that the task will be performed by an internal or external agent, the task is passed to the internal or external agent via block 522. If the task is to be performed by an internal agent, the task is passed to a designated task-specific internal agent 504. The task specific internal agent 504, at 524, receives a task description and relevant context (e.g., contextual or supplemental data) and executes the task at 526. Execution of the task may include, for example, initiating a defined workflow or task, running an automation, running one or more scripts, and so forth. Upon completion of the task, the task specific internal agent 504 outputs an agent execution result 528, which is passed by the task specific internal agent 504 to the manager agent 500.

If, at 522, the task is to be performed by one or more external or secondary agents 508, an external agent invoker 530, which may be a software module defined by a portion of code, may be utilized to invoke one of more external agents 508 via an agent interconnect 532 (e.g., via an API). External agents 508 may be agents operated and/or provided by one or more organizations or external to the enterprise, such as service providers. The external agents 508 may be accessed via one or more APIs, a web interface, a native application, a plugin, and/or one or more protocols. For example, the virtual agent 300 may transmit a greeting message to a secondary agent 508 to activate the secondary agent. The secondary agent 508 responds with a predefined message requesting context. The virtual agent 300 then sends a context message that includes a conversation history to act as context. As with the task specific internal agent 504, the one or more external agents 508 being utilized receive a task description, along with the relevant context at 524 (e.g., contextual or supplemental data) and execute the task at 526, which may include, for example, initiating a defined workflow or task, running one or more scripts, and so forth. In some embodiments, the external agents 508 may take control of a chat conversation with the requestor. Upon completion of the task, the external agent 508 returns an agent execution result 528 via the agent interconnect 532 and the external agent invoker 530, which is passed to the manager agent 500.

Returning to 520, if the task can be performed via an action performed by the executor agent 502, the executor agent 52 proceeds to 534 and determines whether all action inputs are available (e.g., does the executor agent 502 have all of the inputs it needs to perform the action). If the executor agent 502 has all of the inputs to perform the action, the executor agent 502 proceeds to 536 and gets inputs from contextual data when the task was received from the manager agent 500. At 538, the executor agent 502 runs the action, which results in outputs 540. The executor agent 502 passes the outputs 540 to the manager agent 500 as task execution results 542.

As shown, at 544, the agent execution result 528 and/or the task execution result 542 are received by the manager agent 500. At 546, the manager agent 500 performs reflection with the agent execution result 528 and/or the task execution result 542. Reflection is a way of self-correcting current execution plans based on changing circumstances or additional context that becomes available in the middle of execution. This may include, for example, analyzing whether the execution result is reasonable, passing the execution result to some external resource (e.g., a person, an LLM, an algorithm, etc.) for analysis and/or evaluation, or otherwise seeking feedback on the execution result. In some embodiments, reflection may occur at the end of execution. In such embodiments, upcoming steps may be modified based on the result of the current subtask execution. In most situations, subtasks depend on the results of previous subtasks. For example, if a particular asset needs to be assigned to a user as a part of a subtask, it depends on whether enough units of the asset are available and whether the user already has that asset assigned to them. If the previous subtasks were for obtaining these numbers, then the current subtask depends on their result. The decomposition needs to be modified to account for these results via reflection. In some embodiments, reflection may occur when a subtask is unresolved or not completed. If delegation does not yield a valid resolution for the current subtask, the subtask is further decomposed and/or recontextualized to increase the likelihood of success of semantic search. This kind of reflection may or may not utilize input from the user.

At 548, the manager agent 500 increments the index of the current task, which may include, for example, generating a new record, or updating an existing record, in an index for the task with data indicative or various aspects of performance of the task (e.g., was the task completed, was user input requested during performance of the task, was the output determined to be reasonable and/or acceptable, were any external resources utilized to complete the task, were there multiple attempts to complete the task, etc.).

If, at 534, all of the inputs to perform the task are not available, the executor agent 502, at 550, gets inputs from the user. In some embodiments, the executor agent 502 may transmit a message requesting inputs to the client device, or may utilize the communication agent 506 (e.g., via the manager agent 500) to request an input from the user (e.g., via a client device). At 552, the executor agent 502 may request assistance form the manager agent 500 (e.g., to send a message to the client device, invoke the communication agent 506, request input from the user, etc.). At 554, the manager agent 500 updates a progress record of the task to indicate that user input is to be requested at the next iteration.

Returning to 516, if the manager agent 500 cannot identify a resolution and/or input will be requested, as indicated by 556, the manager agent 500 invokes the communication agent 506 to seek user input. As shown, the communication agent 506 may utilize push notifications 558, a chat session 560, email 562, or some combination thereof, to seek input from a user (e.g., via a client device). Further, in some embodiments, the communication agent 506 may consult work notes 564 for assistance in obtaining the user input sought. At 556, the manager agent 500 updates progress data for the task with the user input. In some embodiments, the user input may be provided to an internal agent 504 or external agent 508 for task execution.

At 568, the manager agent 500 receives user inputs from the communication agent 506 for as reflection. Specifically, at 570, the manager agent 500 may receive user inputs providing feedback and/or guidance on the current execution plan, which the manager agent 500 may use to modify the current execution plan. This may include, for example, guidance on next steps if the manager agent is stuck. At 572, the manager agent 500 increments the index of the current task, which may include, for example, generating a new record in an index for the task with data indicative or various aspects of performance of the task (e.g., was the task completed, was user input requested during performance of the task, was the output determined to be reasonable and/or acceptable, were any external resources utilized to complete the task, were there multiple attempts to complete the task, etc.).

At 574, the manager agent 500 determines whether the present task or subtask is the last task in the plan. If so, the manager agent 500 marks the resolution plan for termination. If not, the manager agent 500 returns to block 512 and begins the next iteration in the resolution plan by proceeding to the next task or subtask in the plan.

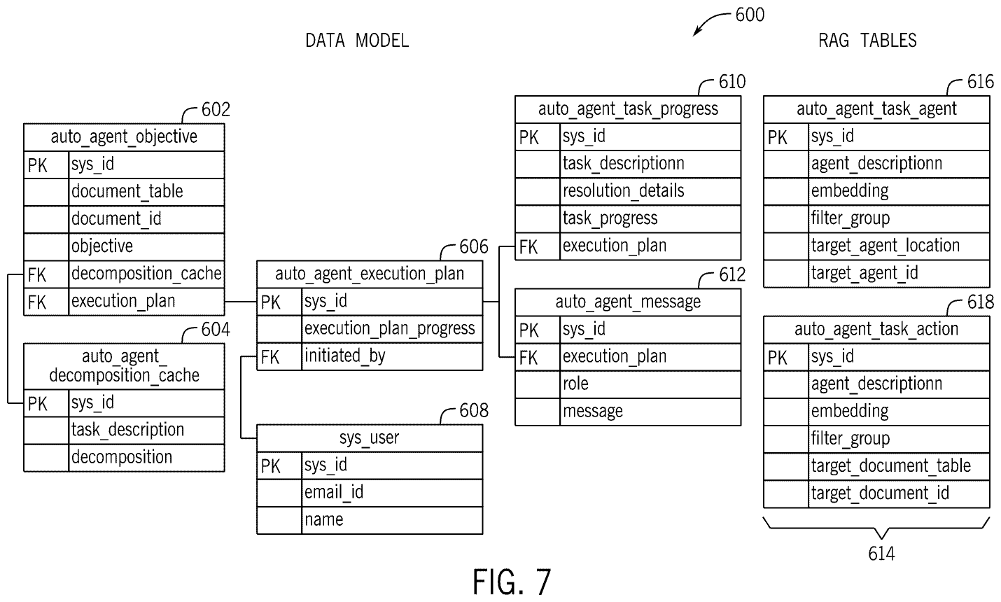

FIG. 7 illustrates a data model 600 used for process performance via one or more autonomous agents. As shown, an autonomous agent objective table 602 includes fields for system identification, document table identification, document identification, an agent objective, a decomposition cache, and an execution plan for performing the process. The decomposition cache field is retrieved from an autonomous agent decomposition cache table 604, which includes fields for system identification, a task description, and a decomposition. The execution plan field of the autonomous agent objective table 602 is provided to an autonomous agent execution plan table 606, which includes fields for system identification, execution plan progress, and an initiated by field that identifies the person who initiated the process. The initiated by field may be populated based on a system user table 608 that includes fields for system identification, email identification of a user and a name of the user. The autonomous agent execution plan table 606 may provide data to an autonomous agent task progress table 610 and an autonomous agent message table 612. The autonomous agent task progress table 610 may include fields for system identification, description of a task, resolution details for the task, progress of the task, and an execution plan for completing the task and/or process. The autonomous agent message table 612 includes fields for system identification, an execution plan, agent/user role, and a message.

As shown, the data model 600 may also include one or more retrieval augmented generation (RAG) tables 614. RAG is a framework that combines generative large language models (LLMs) with traditional information retrieval systems by providing LLMs with access to external information sources (e.g., knowledge bases) before generating an output to improve the output of the LLMs. For example, as shown in FIG. 7, the RAG tables may include an autonomous agent task agent table 616 and an autonomous agent task action table 618. The autonomous agent task agent table 616 that includes information about an agent used to perform a task. The autonomous agent task agent table 616 may include fields for system identification, a description of the agent, embeddings, filter groups, target agent locations, and target agent identification. The autonomous agent task action table 618 may include executable automations or workflows (non-agent entities) that any given subtask can be mapped to and are accessible for assignment to a generated subtask at runtime via embedding search. It should be understood, however, that the data model illustrated in FIG. 7 is merely an example and that other data models are envisaged. Accordingly, the data model of FIG. 7 is not intended to limit the scope of the claims.

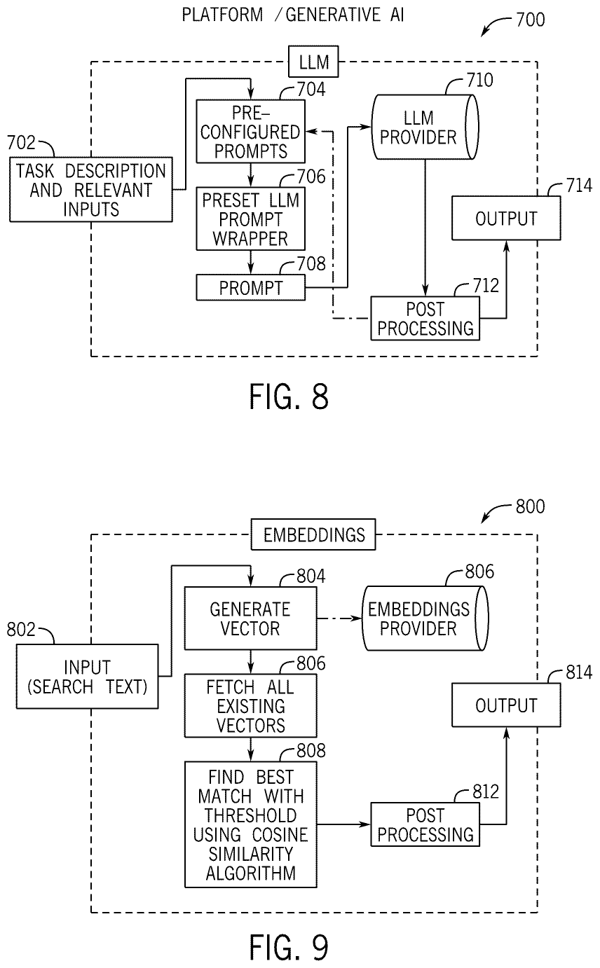

FIG. 8 is a flow chart of a process 700 for LLM-based search that may be used by one or more agents in task decomposition, task performance, reflection, etc. At 702 a task description and/or relevant inputs (e.g., contextual data, user inputs, etc.) are received. Pre-configured prompts 704 (e.g., prompt templates) and/or preset LLM prompt wrappers 706 are used to generate a prompt 708 based on the received task description and/or relevant inputs. At 710, the prompt is provided to an LLM provider, which may run one or more LLMs. The LLM provider provides the prompt as an input to one or more LLMs and returns a result, which may go through some post processing at 712. For example, the post processing 712 may include determining whether the result is reasonable, expected, falls within an acceptable range, does not fall above or below one or more threshold values, etc. If the post processing 712 determines that the output is not usable, the process 700 may return to 704 and generate a new or improved prompt 708, which may be provided to the LLM provider 710 again. Post processing 712 may also result in one or more changes to the result to make the result more usable. Following post-processing, the process 700 generates a usable output 714.

FIG. 9 is a flow chart of a process 800 for an embeddings-based search (e.g., semantic search) that may be used by one or more agents in task decomposition, task performance, reflection, etc. An embedding is a way to represent an object (e.g., text, audio, images, etc.) as points in vector space. At 802 an input (e.g., search text) is received. At 804, a vector is generated based on the input that represents the input as a point in multi-dimensional vector space. At shown, the inputs 802 may be provided to an embeddings provider 806, which generates embeddings (e.g., vector representations) for received inputs. At 808, the process 800 fetches all existing vectors. At 810, the process 800 identifies, from all of the existing vectors fetched in 808, a best match for the vector generated at 804 using a cosine similarity algorithm, or some other algorithms to assess vector similarity. At 812, the process 800 may go through post processing. For example, the post processing 812 may include determining whether the result is reasonable, expected, falls within an acceptable range, does not fall above or below one or more threshold values, etc. Post processing 812 may also result in one or more changes to the result to make the result more usable. Following post processing, the process 800 generates a usable output 814.

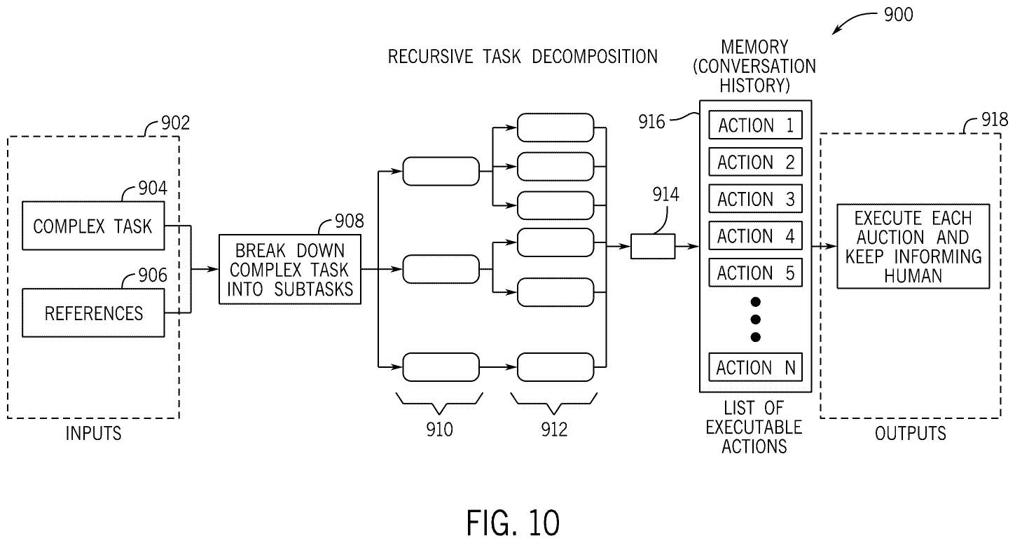

FIG. 10 is a flow chart of a process 900 for recursive task decomposition. As shown, the process 900 receives one or more inputs 902. The inputs 902 may include a description of, or reference to, a complex task 904 or process to be performed. In some embodiments, the inputs 902 may also include one or more references 906 (e.g., supplemental data, contextual data, etc.) to be used in performance of the complex task. At 908, the process 900 breaks down the complex task into subtasks. At 910, the subtasks that can be further broken down, or cannot be performed via existing actions and workflows, are broken down into simpler tasks. At 912, the simpler tasks are further broken down into even simpler tasks and so forth until all of the resulting tasks cannot be broken down further and/or until all of the resulting tasks can be performed via existing actions or workflows.

As shown, in some embodiments, the process 900 may breakdown tasks, subtasks, simpler tasks, etc. using one or more LLMs. For example, the process may provide a task, subtask, simpler task, etc. to an LLM with a request to further break down the task, subtask, simpler task, etc. into subtasks, simpler tasks, etc. However, in other embodiments, the process 900 may apply other techniques to breakdown tasks, such as application of an algorithm, using embeddings, as shown in FIG. 9, and so forth.

At 914, the resulting tasks are put in order based on dependencies between tasks and output. At 916, an ordered list of executable actions is saved in memory. As actions are executed, outputs 918 may be generated to keep the requestor informed about the progress of the requested process and/or to request information from the requestor.

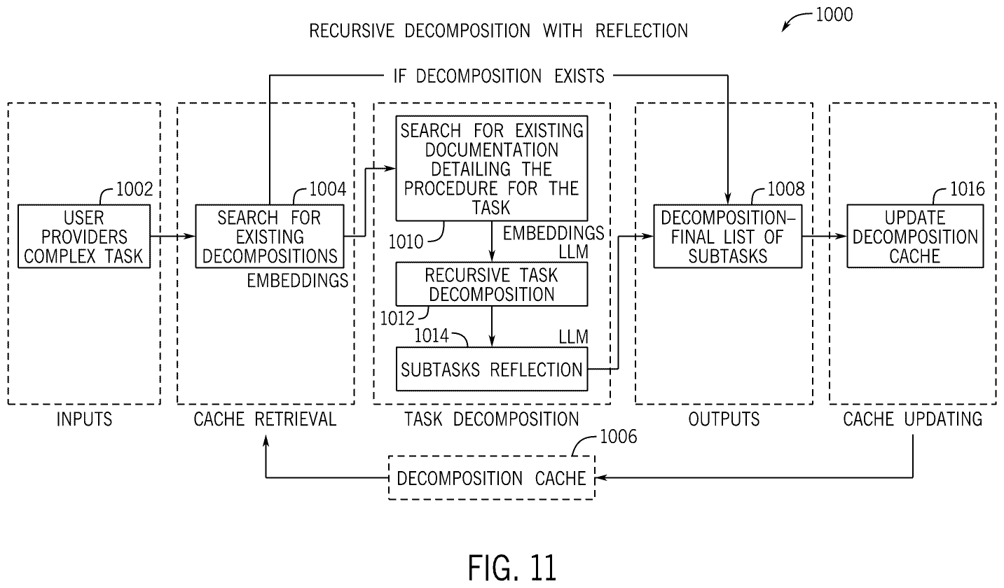

FIG. 11 is a flow chart of a process 1000 for performing recursive decomposition with reflection, which may include the LLM-based search process 700 of FIG. 8 and the embedding-based search process 800 of FIG. 9. At 1002, inputs are received requesting performance of a complex task or process. Though not shown, in some embodiments, the inputs may include supplemental and/or contextual data to be used during performance of the process 1000. At 1004, the embedding-based search process 800 of FIG. 9 is used to search for existing decompositions of the complex task. For example, data may be retrieved from a decomposition cache 1006. A vector may be generated for the complex task. The decomposition cache 1006 may include decompositions for previously requested complex tasks expressed as vectors. Data retrieved from the decomposition cache 1006 may be compared to the vector generated for the complex task requested at 1002 to identify whether any decompositions in the decomposition cache 1006 match the requested task. If so, the process 1000 outputs a final list of subtasks for performing the requested complex task based on the matching decomposition found in the decomposition cache 1006.

If the there are no decompositions in the decomposition cache 1006 that match the requested task, the process proceeds to block 1010 and searches existing documentation for information regarding a procedure for performing the complex task. Any references found may be provided as input references 906 to the recursive task decomposition process 900 shown in FIG. 10. As shown, the recursive task decomposition process 900 shown in FIG. 10 may result in a first draft of a list of tasks, along with the reference used to generate the list of tasks. At 1014, the process 1000 may perform reflection on the list of subtasks be seeking feedback from the user, an LLM, an algorithm, or some other resource. In some embodiments, feedback may be provided and the recursive task decomposition process 900 shown in FIG. 10 performed again using the feedback as an additional reference, until the list of tasks has been approved and/or accepted and provided as outputs (block 1008). At 1016, the decomposition cache 1006 is updated based in the output list of subtasks 1008 and the input complex tasks 1002.

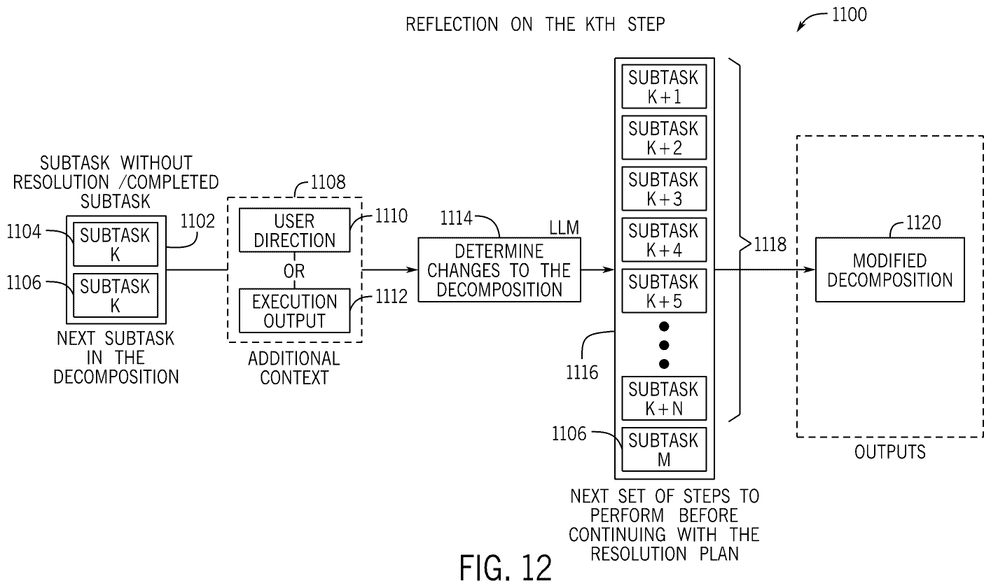

FIG. 12 is a flow chart of a process 1100 for decomposition reflection. As shown, the process 1100 receives an input 1102 that may include, for example, identification of a first subtask 1104 that has not been resolved or completed and a second subtask 1106 that appears next in a decomposition. Accordingly, the goal of the process 1100 is to identify one or more additional subtasks that may be performed to resolve or complete the first subtask 1104 so the second subtask 1106 can be performed. At 1108, the process 1100 receives additional context, which may be in the form of user direction 1110 (e.g., user inputs received from a client device), execution output 1112 from the attempted execution of the first subtask, outputs from completion of previous tasks, feedback from an LLM, and so forth. At 1114, the process 1100 determines one or more changes to the decomposition such that the first subtask can be resolved and/or completed, or to further break down the first subtask 1104 into one or more simpler tasks. To determine changes to the decomposition, the process 1100 may utilize an LLM, a person, a virtual agent, etc. At 116, the process 1100 generates a new list of subtasks that includes one or more additional subtasks 1118 to perform before performing the second subtask 1106. The modified decomposition 1120 is then provided as an output.

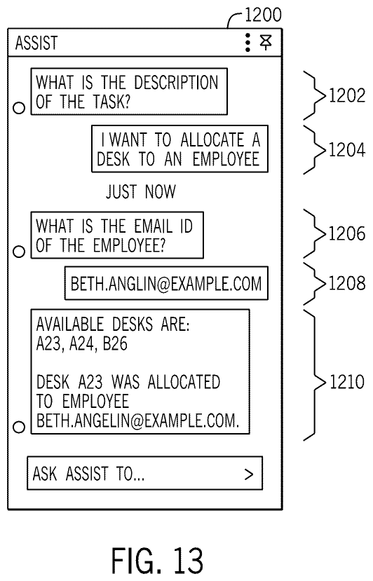

FIG. 13 is a screenshot of a chat conversation 1200 in which a process is requested and performed via an autonomous agent. At 1202, the autonomous agent asks a requestor for a description of the task to be performed. At 1204, the requestor indicates that he or she would like for the autonomous agent to allocate a desk to an employee. At 1206, the autonomous agent asks for the email address of the employee to whom the desk will be allocated. At 1208, the requestor provides the employee's email address. At 1212, the autonomous agent identifies available desks and then assigns one of the available desks to the employee. Though the requested process in the chat conversation 1200 of FIG. 13 is relatively simple, it should be understood that the disclosed techniques may be utilized to perform many additional processes, including more complex processes, via an autonomous agent.

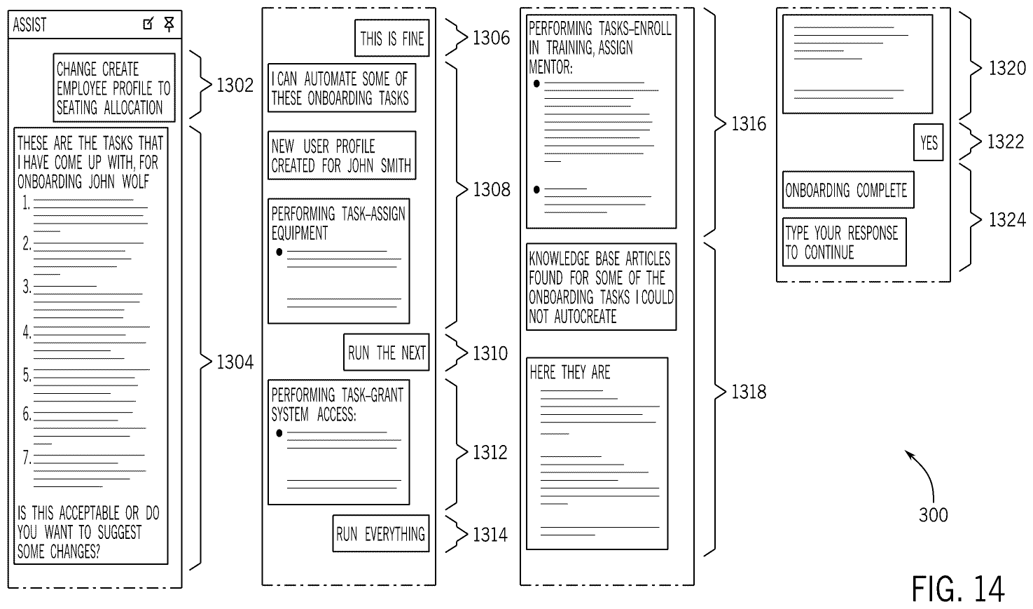

FIG. 14 is a screenshot of a chat conversation 1300 in which another process is requested and performed via an autonomous agent. At 1302, the requestor asks for help onboarding a new employee. At 1304, the autonomous agent presents the requestor with an ordered list of tasks the autonomous agent has come up with for onboarding the new employee for approval. These tasks include, for example, generating an email address, assigning equipment (e.g., computer, phone, headset, etc.) to the employee, granting access to the new employee for computers, software, etc., scheduling orientation for the employee, enrolling the employee in training, allocating a desk/seating for the new employee, and assigning a mentor to the employee. At 1304, the requestor approves the proposed tasks. At 1308, the autonomous agent indicates that it can automate some of the proposed tasks and provides updates as it performs tasks, such as creating a new profile and assigning equipment. At 1310, the requestor instructs the autonomous agent to initiate the next task. At 1312, the autonomous agent provides a status update and indicates that it is granting system access to the employee. At 1314, the requestor instructs the autonomous agent to perform all of the remaining tasks. At 1316, the autonomous agent indicates that the employee has been enrolled in training and that emails have been sent to other employees. At 1318, the autonomous agent notifies the requestor that some tasks could not be automated, but the autonomous agent was able to find knowledge base articles that may be related to these tasks that could be used as references. The autonomous agent then provides links to the knowledge base articles and asks the requestor to provide some guidance about how to perform these tasks. At 1320, the autonomous agent indicates that some of the tasks could not be automated and asks the requestor if generic requests should be created for these tasks. At 1322, the requestor indicates that generic requests should be created. At 1324, the autonomous agent indicates that the generic requests have been created and that onboarding is complete.

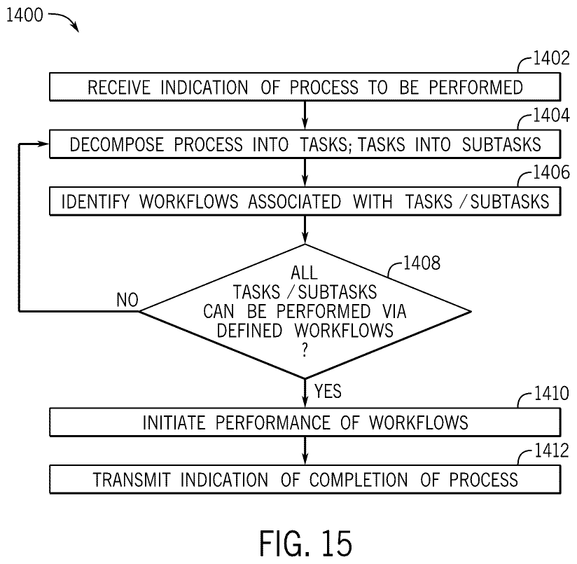

FIG. 15 is a flow chart of a process 1400 for performing a complex process via an autonomous agent in which decomposition is performed before any of the tasks are initiated. At 1402, the process 1400 receives an indication of a process to be performed. The indication may be received (e.g., from a client device) via a chat message, an email, a database query, a web browser, a native application, a command received via an API, and so forth. At 1404, the process 1400 decomposes the process into tasks, decomposes tasks into subtasks, decomposes subtasks into simpler tasks and so forth. In some embodiments, the process 1400 may utilize LLMs, embeddings, searching services, knowledge bases, and other resources to decompose the process until components of the process cannot be broken down any further, or until all of the components of the process can be performed via existing workflows/actions or via available agents. In some embodiments, decomposing the process may include requesting feedback from the requestor, an LLM, or other resources. Decomposition enables complex processes to be broken down in to actionable tasks that can be performed autonomously by the autonomous agent, whereas previously a human would have to intervene and build up a process using existing workflows and actions as building blocks, defining new actions and workflows as needed. Accordingly, the disclosed techniques drastically increase the capabilities of the autonomous agent and allow the autonomous agent to teach itself to perform tasks, thus reducing time and resources spent programming workflows and actions to be performed by an agent. Accordingly, at block 1408, the process 1400 determines whether all tasks and/or subtasks can be performed via existing workflows, actions, or agents. If not, the process 1400 proceeds to 1404 and continues to further decompose the process. If the process 1400 determines that all of the tasks and/or subtasks can be performed via existing workflows, actions, or agents, the process proceeds to block 1410 and initiates performance of the decomposed tasks via the existing workflows, actions, and agents. At 1412, the process 1400 provides an indication that the process has been completed.

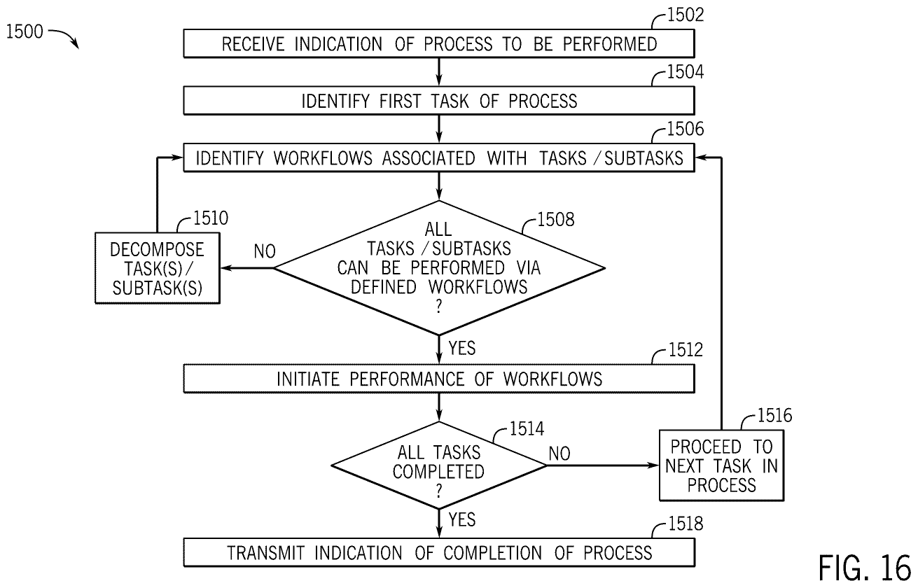

FIG. 16 is a flow chart of a process 1500 for performing a complex process via an autonomous agent in which decomposition is performed iteratively as tasks are performed. At 1502, the process 1500 receives an indication of a process to be performed. The indication may be received (e.g., from a client device) via a chat message, an email, a database query, a web browser, a native application, a command received via an API, and so forth. At 1504, the process 1400 identifies a first task or subtask of the process. In some embodiments, the process 1500 may utilize LLMs, embeddings, searching services, knowledge bases, and other resources to decompose the process. Further, decomposing the process may include requesting feedback from the requestor, an LLM, or other resources. At 1506, the process 1500 identifies one or more existing workflows and/or existing actions associated with the task or subtask identified at 1504. At block 1508, the process 1500 determines whether the task/subtask can be performed via existing workflows, actions, or agents. If not, the process 1500 proceeds to 1510 and continues to further decompose the task/subtask into simpler tasks. Decomposition enables complex processes to be broken down in to actionable tasks that can be performed autonomously by the autonomous agent, whereas previously a human would have to intervene and build up a process using existing workflows and actions as building blocks, defining new actions and workflows as needed. Accordingly, the disclosed techniques drastically increase the capabilities of the autonomous agent and allow the autonomous agent to teach itself to perform tasks, thus reducing time and resources spent programming workflows and actions to be performed by an agent. If the process 1400 determines that the task/subtask can be performed via existing workflows, actions, or agents, the process 1500 proceeds to block 1512 and initiates performance of the task/subtask via the existing workflows, actions, and agents. At 1514, the process 1500 determines whether all tasks have been completed. If not, the process 1500 proceed to the next task in the process (block 1516) and returns to 1506 to identify workflows, actions, or agents associated with the next task in the process. If all tasks have been completed, the process 1500 proceeds to 1518 and provides an indication that the process has been completed.

The presently disclosed techniques are directed to performing processes via an autonomous agent. A natural language request to perform a process may be received from a client device. The autonomous agent decomposes the process into a group of tasks. In some cases, individual tasks may be further decomposed into subtasks, which may be even further decomposed, and so on, until the process has been decomposed into a sequence of existing workflows and/or automations. If a task or subtask cannot be decomposed into components made up of existing workflows and/or automations, new workflows and/or automations may be created based on one or more pieces of contextual information (e.g., related knowledge base articles). In some embodiments, the process may be fully decomposed before any of the tasks or subtasks are performed. In such embodiments, the autonomous agent may provide the decomposed process to an LLM and/or to the client device for approval. In other embodiments, the autonomous agent may identify a first task, provide the proposed first task to an LLM and/or the client device for approval, upon receipt of approval, perform the first task, identify a subsequent task, provide the proposed subsequent task to an LLM and/or the client device for approval, upon receipt of approval, perform the subsequent task, and so on until the process is completed. In some embodiments, the autonomous agent may be a primary autonomous agent that delegates performance of tasks and/or subtasks to one or more secondary agents. In such embodiments, the primary autonomous agent may utilize more sophisticated, and thus more expensive to operate, large language models (LLMs), whereas the secondary autonomous agent may utilize more general purpose LLMs to perform tasks and/or subtasks. In some embodiments, however, secondary autonomous agents may utilize more specialized LLMs to perform more specific tasks. If the autonomous agent is unable to perform a task or subtask autonomously, the autonomous agent may request help and/or input from a human agent, or may transmit a request for more information or additional input to the client device. By utilizing the disclosed techniques, performance of processes within an enterprise may include improved selection of workflows and/or automations, more efficient utilization of computing resources in performing processes, reduced downtime in performance of tasks and/or subtasks waiting on human inputs, and fewer errors that may cause incorrect performance of processes and/or incorrect results of processes.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S. C. 112(f). However, for any claims containing elements designated in any other manner, it is intended that such elements are not to be interpreted under 35 U.S. C. 112(f).

1. A method comprising:
receiving, from a client device, an indication of a process to be performed;
identifying a first workflow associated with a first task of the process, and identifying a second workflow associated with a second task of the process;
initiating performance of the first and second workflows; and
transmitting, to the client device, an indication of completion of the performance of the first and second workflows.

2. The method of claim 1, comprising decomposing the process into the first task and the second task.

3. The method of claim 2, comprising:
decomposing the first task into a first subtask and a second subtask; and
initiating performance of the first subtask and the second subtask.

4. The method of claim 2, comprising:
decomposing the process into the first task, the second task, and a third task;
in response to identifying no workflows that are associated with the third task, generating, based on contextual information, a new workflow associated with the third task; and
initiating the new workflow associated with the third task.

5. The method of claim 2, comprising:
providing the decomposed process as an input to a large language model (LLM); and
receiving, from the LLM, an output confirming the decomposed process.

6. The method of claim 2, comprising:
providing the decomposed process to the client device; and
receiving, from the client device, an approval of the decomposed process.

7. The method of claim 2, wherein decomposing the process into the first task and the second task is performed via a first agent, and wherein initiating the performance of the first workflow associated with the first task is via a second agent.

8. The method of claim 7, wherein initiating the performance of the second workflow associated with the second task is via a third agent.

9. The method of claim 2, wherein decomposing the process comprises breaking the process into a plurality of tasks, including the first task and the second task, and breaking the plurality of tasks into a plurality of subtasks until the plurality of tasks and subtasks are capable of performance via a plurality of defined workflows.

10. The method of claim 1, wherein initiating the performance of the first workflow associated with the first task occurs prior to identifying the second workflow associated with second task.

11. The method of claim 1, wherein identifying the second workflow associated with the second task occurs prior to initiating the performance of the first workflow associated with the first task.

12. The method of claim 1, comprising providing an output of the first task to the client device.

13. The method of claim 1, comprising providing an output of the process to the client device.

14. The method of claim 1, comprising:
transmitting, to the client device, a request for an input to complete the first workflow;
receiving, from the client device, the input; and
completing the first workflow based on the received input.

15. The method of claim 1, wherein the indication of the process to be performed comprises a natural language indication of the process.

16. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving, from a client device, an indication of a process to be performed;
identifying a first workflow associated with a first task of the process, and identifying a second workflow associated with a second task of the process;
initiating performance of the first and second workflows; and
transmitting, to the client device, an indication of completion of the performance of the first and second workflows.

17. The system of claim 16, wherein the operations comprise decomposing the process into the first task and the second task.

18. The system of claim 16, wherein the operations comprise:
decomposing the process into the first task, the second task, and a third task;
in response to identifying no workflows that are associated with the third task, generating, based on contextual information, a new workflow associated with the third task; and
initiating the new workflow associated with the third task.

19. A non-transitory, computer readable medium comprising instructions that, when executed by processing circuitry, cause the processing circuitry to perform operations comprising:
receiving, from a client device, an indication of a process to be performed;
identifying a first workflow associated with a first task of the process, and identifying a second workflow associated with a second task of the process;
initiating performance of the first and second workflows; and
transmitting, to the client device, an indication of completion of the performance of the first and second workflows.

20. The non-transitory, computer readable medium of claim 19, wherein the operations comprise:
decomposing the process into the first task, the second task, and a third task;
in response to identifying no workflows that are associated with the third task, generating, based on contextual information, a new workflow associated with the third task; and
initiating the new workflow associated with the third task.
